(19) United States
(12) Patent Application Publication
(10) Pub. No.: US 2014/0124966 A1
(43) Pub. Date: May 8, 2014

(54) METHOD AND DEVICE FOR MANUFACTURING TREATED FILM

(71) Applicants: Kazuya Hada, Ibaraki-shi (JP); Satoshi Hirata, Ibaraki-shi (JP); Masakazu Mochizuki, Ibaraki-shi (JP); Seiji Kondo, Ibaraki-shi (JP)

(72) Inventors: Kazuya Hada, Ibaraki-shi (JP); Satoshi Hirata, Ibaraki-shi (JP); Masakazu Mochizuki, Ibaraki-shi (JP); Seiji Kondo, Ibaraki-shi (JP)

(73) Assignee: NITTO DENKO CORPORATION, Ibaraki-shi, Osaka (JP)

(21) Appl. No.: 14/130,222

(22) PCT Filed: Jul. 5, 2012
(86) PCT No.: PCT/JP2012/067213

§ 371 Date: Dec. 30, 2013

(30) Foreign Application Priority Data
Jul. 12, 2011 (JP) 2011-154076

(51) Int. Cl. B29D 11/00; B29C 71/00

(52) U.S. Cl. CPC B29D 11/00644; B29D 11/00788; B29C 71/0009
USPC 264/1.34; 264/165; 264/1.6; 425/71

(57) ABSTRACT

A method for manufacturing a treated resin film from a long resin film, the method including at least treatment steps each including treating the long resin film by bringing the long resin film into contact with a treatment liquid in a treatment tank, while feeding the long resin film, wherein at least one of the treatment steps is a one-side contact step including bringing a lower surface of the resin film into contact with a surface of the treatment liquid in the treatment tank that is filled with the treatment liquid, and nip rolls are placed downstream of at least one one-side treatment tank for the one-side treatment step. The method is capable of satisfying the properties required of the treated film and also capable of reducing the occurrence of scratches, dents, and other defects.

### TECHNICAL FIELD

The invention relates to a method and an apparatus for manufacturing a treated resin film from a resin film. The resin film can be selected as appropriate from resin films used in a variety of fields, depending on the object to be treated. Specifically, the treated film may be any of a variety of treated films required to have no fine scratches. In particular, the invention is suitable for use in at least one treatment step of a swelling step, a dyeing step, a crosslinking step, a stretching step, and a cleaning step in a polarizer manufacturing process, where a polyvinyl alcohol-based film or the like is typically used as the resin film.

In addition, any of a variety of optical films such as transparent protective films of cellulose ester resin or other materials, for use on polarizers, can also be used as the resin film, and the invention is also suitable for use in at least one treatment step of a saponification step and a subsequent aqueous cleaning step. Optical films including a polarizer and other products can be used in image display devices such as liquid crystal display devices, electroluminescence (EL) display devices, plasma displays (PDs), and field emission displays (FEDs).

### BACKGROUND ART

Image display devices (especially, liquid crystal display devices) are produced using optical films such as polarizers. In general, such polarizers are manufactured by dyeing and uniaxially stretching a polyvinyl alcohol (PVA) film. When a PVA film is uniaxially stretched, a dichroic material (dye) adsorbed on the PVA molecule is oriented, so that a polarizer is formed.

As the size, performance, and brightness of liquid crystal display devices increase, the size of polarizing plates for use therein increases, and at the same time, the optical properties and in-plane uniformity of polarizing plates are required to be improved. To obtain a large polarizing plate, it is necessary to uniformly stretch a PVA film used as a raw material for a polarizer. Unfortunately, uniform stretching is a very difficult process, in which in-plane uniformity and optical properties tend to be degraded. For example, Patent Document 1 proposes a method including stretching a PVA film by a tenter method, while bringing the whole of the PVA film into contact with a liquid. Unfortunately, a bath is necessary for immersion of the PVA film in the liquid when it is brought into contact with the liquid. Therefore, this method tends to require a large manufacturing apparatus. Additionally, in the tenter method, it is difficult to shift the PVA film vertically because of the structure of the tenter. Therefore, a combination of stretching by the tenter method and immersion of a PVA film in a bath, which are performed at the same time, requires a very complicated structure.

To solve these problems, therefore, Patent Document 2 discloses a method for manufacturing a polarizer in which bringing a liquid into contact with a hydrophilic polymer film and transversely stretching the polymer film by a tenter method or the like can be performed at substantially the same time using a small and simple manufacturing apparatus.

Unfortunately, in this method, a spraying method is used to bring the liquid into contact with the polymer film, and therefore, unevenness may occur because it is difficult to uniformly spray the liquid on the surface of the polymer film. On the other hand, the liquid may be brought into contact by a coating method, but in such a case, there is a problem in which it is necessary to make a large coating device, which will increase manufacturing cost.

In recent years, as liquid crystal display devices have come to have higher performance, higher visibility has been required. At the same time, it has become very important that polarizing plates should also have higher transmittance and provide better visibility. In a polarizing plate, therefore, a polarizer and a transparent protective film therefor are all required not to interfere with visibility. Polarizing plates having scratches or dents (spot flaws) are also not preferable because they can be rejected as defective by product inspection so that product yield ratio can decrease. In a polarizing plate, which is a laminate of a polarizer and a transparent protective film, the polarizer and the transparent protective film are usually bonded together with an adhesive or the like. If the polarizer or the transparent protective film has scratches or dents, the adhesion between the layers with the adhesive or the like can be poor.

The occurrence of scratches (flaws) on a polarizer or a transparent protective film therefor can be a cause of visibility reduction by a polarizing plate. As mentioned above, a polarizer is manufactured by feeding and immersing a polyvinyl alcohol-based film or the like in dyeing liquid and other liquid materials, and on the other hand, a transparent protective film is fed in a saponification treatment bath and an aqueous cleaning treatment bath before it is bonded to the polarizer. In general, when these treatments are performed, the number of scratches or dents formed on these films tends to increase as the production rate increases.

### PRIOR ART DOCUMENTS

### Patent Documents

Patent Document 1: JP-A-2006-91374
Patent Document 2: JP-A-2009-63982

### SUMMARY OF THE INVENTION

### Problems to be Solved by the Invention

It is an object of the invention to provide a method for manufacturing a treated resin film from a long resin film, which includes at least treatment steps each including treating the long resin film by bringing the long resin film into contact with a treatment liquid in a treatment tank, while feeding the long resin film, and is capable of satisfying the properties required of the treated film and also capable of reducing the occurrence of scratches, dents, and other defects, and to provide an apparatus for such a manufacturing method.

### Means for Solving the Problems

As a result of earnest studies to solve the above problems, the inventors have accomplished the invention based on findings that the object can be achieved by the treated film manufacturing method and the treated film manufacturing apparatus described below.

The invention relates to a method for manufacturing a treated resin film from a long resin film, the method including at least treatment steps each including treating the long resin film by bringing the long resin film into contact with a treatment liquid in a treatment tank, while feeding the long resin film, wherein

at least one of the treatment steps is a one-side contact step including bringing a lower surface of the resin film into contact with a surface of the treatment liquid in the treatment tank that is filled with the treatment liquid, and

nip rolls are placed downstream of at least one one-side treatment tank for the one-side treatment step.

In the method for manufacturing a treated resin film may include the step of removing liquid only from a lower surface of the treated film subsequent to the one-side contact step.

In the method for manufacturing a treated resin film, the one-side contact step may be performed while the treatment liquid is supplied, to the one-side treatment tank, in an amount equal to or larger than the amount of the treatment liquid taken out of the one-side treatment tank.

In the method for manufacturing a treated resin film, nip rolls may be placed upstream of the one-side treatment tank, corresponding to the nip rolls placed downstream of the one-side treatment tank, and the one-side contact step may be performed while the long resin film is stretched in longitudinal direction of the long resin film by making the peripheral speed of the nip rolls upstream of the one-side treatment tank different from the peripheral speed of the nip rolls downstream of the one-side treatment tank.

The method for manufacturing a treated resin film is preferably used; in a case the treated film obtained by subjecting the resin film to the treatment steps is an optical film.

The method for manufacturing a treated resin film is preferably used; in a case the resin film is a polyvinyl alcohol-based film, and a polarizer is manufactured as the treated film. In the case, the treatment steps include at least a swelling step, a dyeing step, a crosslinking step, a stretching step, and a cleaning step, at least one of the swelling step, the dyeing step, the crosslinking step, the stretching step, and the cleaning step is performed using the one-side contact step.

The invention also relates to an apparatus for manufacturing a treated film, including:

at least one treatment tank filled with a treatment liquid with which a desired treatment is to be performed on a resin film;

the at least one treatment tank being a one-side treatment tank placed under the resin film being fed, the one-side treatment tank being so placed that a surface of the treatment liquid comes into contact with a lower surface of the resin film; and

nip rolls placed downstream of the at least one one-side treatment tank.

The apparatus may include means for removing liquid from a lower surface of the film treated with the treatment liquid, wherein the means for removing liquid is provided downstream of the one-side treatment tank.

In the apparatus, a treatment liquid supply unit for continuously supplying the treatment liquid to the one-side treatment tank may be provided with the one-side treatment tank.

The apparatus may include nip rolls placed upstream of the one-side treatment tank, corresponding to the nip rolls placed downstream of the one-side treatment tank.

### Effect of the Invention

In the manufacturing method of the invention, a treatment step including bringing a resin film (e.g., a PVA film) into contact with a treatment liquid while continuously feeding the resin film is performed using a one-side contact step including bringing the lower surface of the resin film into surface contact with the surface of the treatment liquid, so that the lower surface of the film can be uniformly treated with no unevenness. Thus, unevenness can be prevented, which would otherwise occur in the case of spray method or coating method. This makes it possible to perform a uniform treatment on the resin film and to satisfy the properties required of the treated film. For example, when a polarizer is manufactured as the treated film using a PVA film as the resin film, the resulting polarizer can have high in-plane uniformity of optical properties.

To improve the performance of a resin film treatment, a conventional coating method needs to apply a large amount of a treatment liquid. In contrast, the one-side contact step in the manufacturing method of the invention makes it possible to improve treatment performance simply by surface contact with a certain amount of a treatment liquid, so that the amount of the treatment liquid used can be kept small. Moreover, when a large optical film is manufactured, a spray or coating method needs to use a large spray or coating apparatus depending on the size of the film. In the manufacturing method of the invention, however, it is enough to simply change the size of the treatment tank, which has a high degree of freedom of apparatus modification and can keep the manufacturing cost low.

In addition, when the one-side treatment tank for the one-side treatment step is provided with a treatment liquid supply unit, the treatment liquid being used in the one-side contact step can be continuously supplied, to the one-side treatment tank, in an amount equal to or larger than the amount of the treatment liquid taken out of the one-side treatment tank. This makes it possible to suppress degradation of the treatment liquid and to prevent the treatment efficiency reduction caused by time degradation of the treatment liquid. Thus, a treated film (an optical film such as a polarizer) having high in-plane uniformity of optical properties can be manufactured from a PVA film as the resin film.

After treated by the one-side contact step, the resin film (treated film) is fed through the nip rolls placed downstream of the one-side treatment tank. It is conceivable that scratches or dents can occur on a treated film when fine contaminants come together with a fluid (treatment liquid) between the treated film and nip rolls so that the contaminants are held between the nip rolls. In the one-side contact step of the manufacturing method of the invention, only one side (lower surface) of the resin film is treated, and thus the fluid comes only between the one side of the nip roll and the treated film after the one-side contact step. Thus, the occurrence of scratches or dents can be significantly reduced as compared to conventional cases where a resin film is immersed in a treatment liquid so that both sides of the resin film are treated.

The treated film obtained in the one-side contact step may be subjected to a liquid removal step including removing the treatment liquid from the surface of the treated film. When a resin film is subjected to a conventional treatment step including immersing the resin film in a treatment liquid, both sides of the treated film must be subjected to a liquid removal step. In the manufacturing method of the invention, however, it can be enough to perform a liquid removal step only on the lower surface of the treated film after the resin film is subjected to the one-side contact step as a treatment step. In the treated film manufacturing method of the invention, therefore, it can be enough to perform a liquid removal step only on one side, which makes it possible to use an apparatus simpler than a conventional apparatus in performing the liquid removal step.

### BRIEF DESCRIPTION OF THE DRAWINGS

FIG. 1A is a schematic diagram showing an embodiment of the one-side contact step of the method of the invention for manufacturing a treated film;

FIG. 1B is a schematic diagram showing an embodiment of the one-side contact step of the method of the invention for manufacturing a treated film;

FIG. 2A is a schematic diagram showing an embodiment of the one-side contact step of the method of the invention for manufacturing a treated film;

FIG. 2B is a schematic diagram showing an embodiment of the one-side contact step of the method of the invention for manufacturing a treated film;

FIG. 3 is a schematic diagram showing an embodiment of a polarizer manufacturing method according to the invention for manufacturing a treated film; and

FIG. 4 is a schematic diagram showing a polarizer manufacturing method according to a conventional method for manufacturing a treated film; and

FIG. 5 is a picture showing ranks 1 to 3 on the level of unevenness in a polarizer.

### MODE FOR CARRYING OUT THE INVENTION

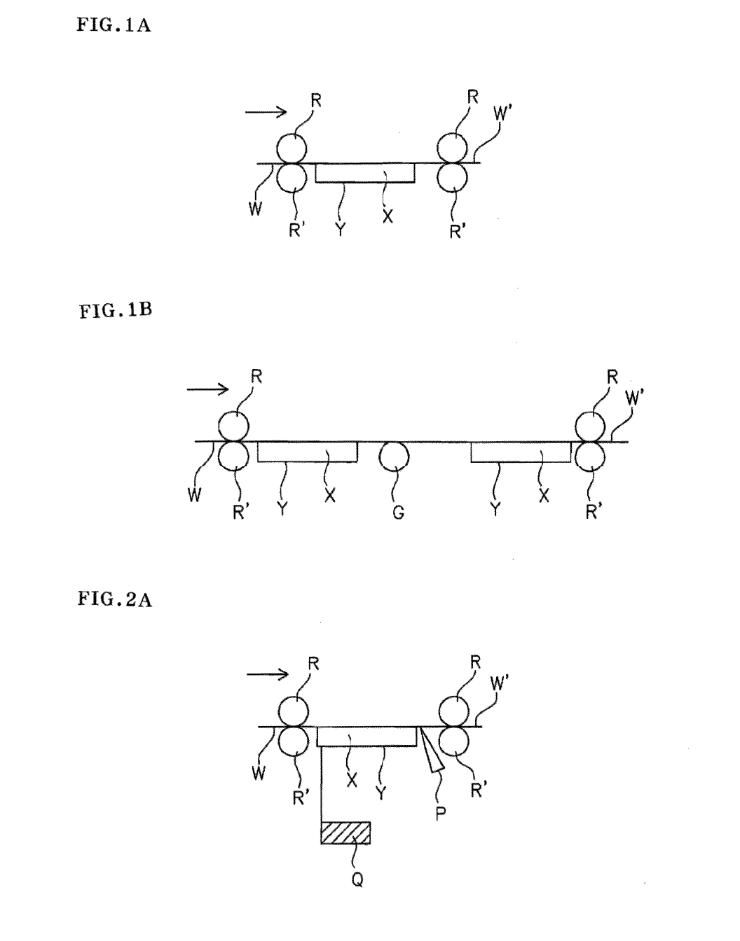

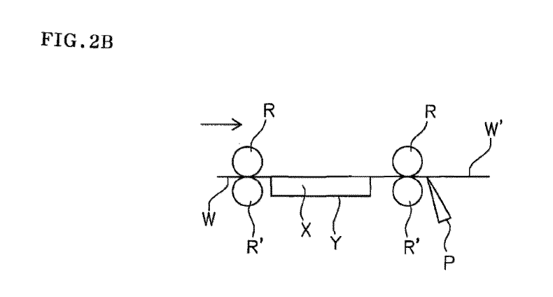

Hereinafter, the method of the invention for manufacturing a treated film will be described with reference to the drawings. FIGS. 1 and 2 each show the one-side contact step of the method of the invention for manufacturing a treated film. FIGS. 1 and 2 each show an embodiment of a system including a resin film W, nip rolls R and R′ including a pair of rolls, and a one-side treatment tank Y containing a treatment liquid X. The nip rolls R and R′ are placed at least downstream of the one-side treatment tank Y. Nip rolls may also be placed upstream of the one-side treatment tank Y, corresponding to the nip rolls R and R′ placed downstream of the one-side treatment tank Y. In FIG. 1A, nip rolls R and R′ are placed upstream and downstream of one one-side treatment tank Y, respectively. In FIG. 1B, two continuous one-side treatment tanks Y are provided, and nip rolls R and R′ are placed upstream of the first tank and downstream of the final tank, respectively. Although FIG. 1B shows that two one-side treatment tanks Y are provided in series, three or more one-side treatment tanks may be provided in series. As shown in FIG. 1B, when one-side treatment tanks Y are provided in series, a guide roll G may be provided between the one-side treatment tanks Y. A resin film W is fed through the nip rolls R and R′.

In general, the resin film W is preferably fed at a rate (mm/minute) in the range of 0.1 to 30 m/minute, more preferably in the range of 1 to 15 mm/minute. When the feed rate is 0.1 mm/minute or more, the treated film W′ (e.g., a polarizer) can be manufactured from the resin film W with higher productivity. On the other hand, when the feed rate is 30 m/minute or less, the convection of the treatment liquid X caused by shearing can be reduced.

The one-side treatment tank Y is filled with a treatment liquid (described in detail below) for use in a desired treatment of the resin film W. The one-side treatment tank Y is so placed that the resin film W passes over the tank Y, and the lower surface of the resin film W comes into surface contact with the surface of the treatment liquid in the one-side treatment tank Y. This makes it possible to prevent uneven treatment, which would otherwise occur in the case of a spraying or coating method, and to perform a uniform treatment on the lower surface of the resin film W. In a preferred mode, the one-side treatment tank Y is horizontally placed so that the surface of the treatment liquid X is kept horizontal, and the resin film W is also fed horizontally. Horizontal placement of the one-side treatment tank Y is preferred. Alternatively, however, the one-side treatment tank Y may be so inclined that its downstream side is higher than its upstream side with respect to the direction in which the film is fed. When the one-side treatment tank Y is placed in such an inclined position that its upstream side is lowered, the resin film can be brought into contact with the treatment liquid X being always allowed to overflow. If the one-side treatment tank Y is so inclined that its upstream side is higher than its downstream side with respect to the direction in which the film is fed, the treatment liquid X will be stopped from flowing out of the upstream side of the one-side treatment tank Y, so that the resin film W can come into contact with the wall surface of the one-side treatment tank Y and the friction at the contact can cause the resin film to vibrate and thus to induce uneven treatment. Thus, it is not preferable to place the one-side treatment tank Y in such an inclined position that its upstream side is higher than its downstream side with respect to the direction in which the film is fed.

When the resin film W is brought into contact with the surface of the treatment liquid X, only the lower surface of the film W is treated with the treatment liquid X, so that a treated resin film W′ is obtained. In this step, the treatment liquid X can have surface tension. Thus, there may be a distance between the lower surface of the resin film W and the upper surface of the one-side treatment tank Y as long as the distance falls within a certain range. For example, such a distance between the lower surface of the resin film W and the upper surface of the one-side treatment tank Y preferably falls within the range of 0 mm to 5 mm. In such an arrangement, where the liquid surface comes into contact with the lower surface of the resin film W, the contact between them is preferably such that no air bubbles come between them.

The depth (mm) of the treatment liquid in the one-side treatment tank Y is preferably in the range of 1 mm to 500 mm, more preferably in the range of 35 mm to 200 mm. When the depth of the liquid is 1 mm or more, the treatment liquid with which the one-side treatment tank Y is filled can have good conditions for surface-contact with the lower surface of the resin film W. On the other hand, when the depth is 500 mm or less, an excessive amount of use of the liquid can be reduced.

The treatment liquid X preferably has a viscosity of 100 mPa·s or less, more preferably 50 mPa·s or less, even more preferably 10 mPa·s or less. When the treatment liquid X has a viscosity of 100 mPa·s or less, the friction between the lower surface of the resin film W and the treatment liquid can be reduced. As a result, the treatment liquid flow caused by the feeding of the resin film W in contact with the treatment liquid can be suppressed, so that the occurrence of uneven treatment can be reduced.

In FIGS. 1 and 2, the resin film W may be stretched in the longitudinal direction by making the peripheral speed of the nip rolls R and R′ upstream of the one-side treatment tank Y different from the peripheral speed of the nip rolls R and R′ downstream of the one-side treatment tank Y, while the one-side contact step is performed. When stretching is performed in the one-side contact step, the peripheral speeds of the nip rolls R and R′ are usually each so controlled that the peripheral speed of the downstream nip rolls R and R′ is higher than that of the upstream nip rollers R and R′.

FIG. 2A shows a case where liquid removal means P for removing liquid only from the lower surface of the treated film W′ is provided downstream of the one-side contact step in the system shown in FIG. 1A. For example, the liquid removal means P may be a liquid removing roller, a liquid removing bar, a scraper, an air knife, or the like. In particular, a rotary liquid-removing roller or a non-contact air knife is preferred. The liquid removal means P, which is provided downstream of the one-side contact step, may be placed, as shown in FIG. 2A, upstream of the place where the treated film W′ comes into contact with the downstream nip rolls R and R′, or may be placed, as shown in FIG. 2B, downstream of the place where the treated film W′ comes into contact with the downstream nip rolls R and R′. To prevent scratching or denting, it is preferable to place the liquid removal means P upstream of the place where the treated film W′ comes into contact with the downstream nip rolls R and R′.

As shown in FIG. 2, the one-side treatment tank Y may be provided with a treatment liquid supply unit Q. The treatment liquid supply unit Q enables the treatment liquid X to be continuously supplied to the one-side treatment tank Y. In the one-side contact step, where the treatment liquid X is continuously supplied from the treatment liquid supply unit Q, the treatment liquid X may be continuously supplied in an amount equal to or larger than the amount of the treatment liquid X taken out of the one-side treatment tank Y, so that the one-side treatment tank Y can be always filled with the treatment liquid X. In this case, a reduction in treatment efficiency can also be prevented, which would otherwise be caused by time degradation of the treatment liquid X, so that yield ratio can be improved. The treatment liquid supply unit Q is not restricted. For example, the treatment liquid can be supplied using a pump or the like as the treatment liquid supply unit Q.

Any of various resin materials may be used to form the resin film for use in the method of the invention for manufacturing a treated film. The resin material to be used may be appropriately selected from a variety of materials depending on the intended use. A resin material that is optically transparent in the visible region is preferably used in such applications as optical films.

For example, such an optically transparent resin may be an optically transparent water-soluble resin. An example of the resin film produced using an optically transparent water-soluble resin is a PVA film, which is preferably used in the manufacture of a polarizer. Such a PVA film is produced using polyvinyl alcohol or a derivative thereof. Polyvinyl alcohol derivatives include polyvinyl formal, polyvinyl acetal, and polyvinyl alcohols modified with an olefin such as ethylene or propylene, an unsaturated carboxylic acid such as acrylic acid, methacrylic acid, or crotonic acid, or an alkyl ester or acrylamide thereof. Polyvinyl alcohol preferably has a degree of polymerization of about 100 to about 10,000, more preferably 1,000 to 10,000. Polyvinyl alcohol with a degree of saponification of about 80 to 100% by mole is generally used.

Besides the above, the PVA film may also be a hydrophilic polymer film such as an ethylene-vinyl acetate copolymer-based partially-saponified film, or a polyene-based oriented film such as a film of a dehydration product of polyvinyl alcohol or a dehydrochlorination product of polyvinyl chloride.

The PVA film may also contain an additive such as a plasticizer, a surfactant. Examples of the plasticizer include polyols and condensates thereof, such as glycerin, diglycerin, triglycerin, ethylene glycol, propylene glycol, and polyethylene glycol. The content of the plasticizer or the likes in the polyvinyl alcohol-based resin film is preferably, but not limited to, 20% by weight or less.

Examples of the optically transparent water-soluble resin also include polyvinylpyrrolidone resins, amylose resins, etc.

The thickness of the resin film W may be appropriately determined depending on the intended use. The resin film W to be used generally has a thickness of about 10 to about 300 μm, preferably 20 to 100 μm. The resin film W preferably has a width in the range of 100 to 4,000 mm, more preferably in the range of 500 to 3,500 mm.

For example, the resin film W may be a PVA film for use in the manufacture of a polarizer. In this case, for example, its thickness is in the range of 15 to 110 μm, more preferably in the range of 38 to 110 μm, even more preferably in the range of 50 to 100 μm, in particular, preferably in the range of 60 to 80 μm. If the thickness of the PVA film is less than 15 μm, the PVA film may have too low mechanical strength so that it may be difficult to perform uniform stretching and that color unevenness may be more likely to occur when a polarizer is manufactured. On the other hand, if the thickness of the PVA film is more than 110 μm, sufficient swelling may fail to be achieved, so that color unevenness may be enhanced in a polarizer, which is not preferred.

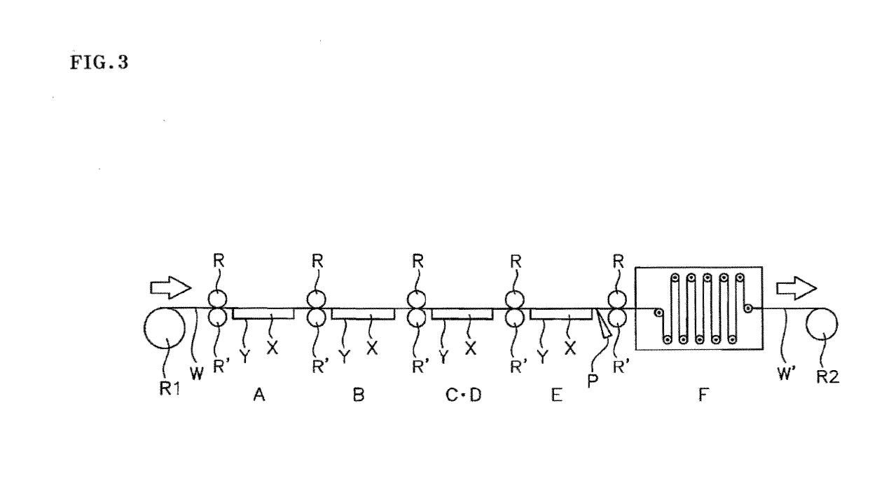

An embodiment of the method of the invention for manufacturing a treated film, in which the resin film is subjected to treatment steps to form an optical film, will be described below with reference to the drawings. FIG. 3 is a schematic diagram showing an example of a method for manufacturing a polarizer, which is in accordance with the method of the invention for manufacturing a treated film. The method for manufacturing a polarizer includes a swelling step A, a dyeing step B, a crosslinking step C, a stretching step D, and a cleaning step E. FIG. 3 shows a case where a polarizer is manufactured by a process including sequentially performing a swelling step A, a dyeing step B, a crosslinking step C, a stretching step D, and a cleaning step E on a resin film (PVA film) W being fed from a material roll, and finally performing a drying step F. In FIG. 3, the crosslinking step C and the stretching step D are performed at the same time in the same treatment tank.

In FIG. 3, the resin film W is fed from a feed roll R1 through nip rolls R and R′ placed upstream and downstream of each one-side treatment tank Y. A roll R2 for taking up the treated film W′ is provided downstream of the drying step F. A pair of nip rolls R and R′ is provided between the respective one-side treatment tanks Y. Alternatively, two or more pairs of nip rolls may be provided between the respective one-side treatment tanks. In FIG. 3, the nip rolls R and R′ placed between the swelling step A and the dyeing step B, between the dyeing step B and the crosslinking and stretching step C/D, or between the crosslinking and stretching step C/D and the cleaning step E serves as both downstream and upstream nip rolls.

In FIG. 3, the type of the treatment liquid X used in each one-side treatment tank Y varies with each of the swelling step A, the dyeing step B, the crosslinking and stretching step C/D, and the cleaning step E. FIG. 3 shows an example where the one-side contact step is performed as a treatment step in all the one-side treatment tanks Y. However, the one-side contact step only has to be performed as a treatment step in at least one of the one-side treatment tanks Y. Thus, the one-side contact step of the method of the invention for manufacturing a treated film may be performed in any one or more or all of the swelling step A, the dyeing step B, the crosslinking step C, the stretching step D, and the cleaning step E in the polarizer manufacturing method. That is to say, in FIG. 3, the nip rolls R and R′ are placed upstream and downstream of each of the swelling step A, the dyeing step B, the crosslinking and stretching step C/D, and the cleaning step E, however, nip rolls R and R′ only have to be placed downstream of the one-side treatment tank Y for at least one of the steps.

When two or more one-side contact steps are performed, any desired one-side contact steps may be selected, and nip rolls may be placed upstream of one of the selected steps and downstream of another one of them. For example, in FIG. 3, nip rolls R and R′ may only be placed upstream of the swelling step A and downstream of the cleaning step E. Alternatively, in FIG. 3, any desired steps may be selected, and, for example, nip rolls R and R′ may be placed upstream of the dyeing step B and downstream of the crosslinking and stretching step C/D.

In FIG. 3, liquid removal means P for removing liquid from the lower surface of the treated film W′ is provided only downstream of the cleaning step E. Alternatively, liquid removal means P may be provided downstream of each one-side treatment tank Y. Although not shown in FIG. 3, each one-side treatment tank Y may be provided with treatment liquid supply means Q.

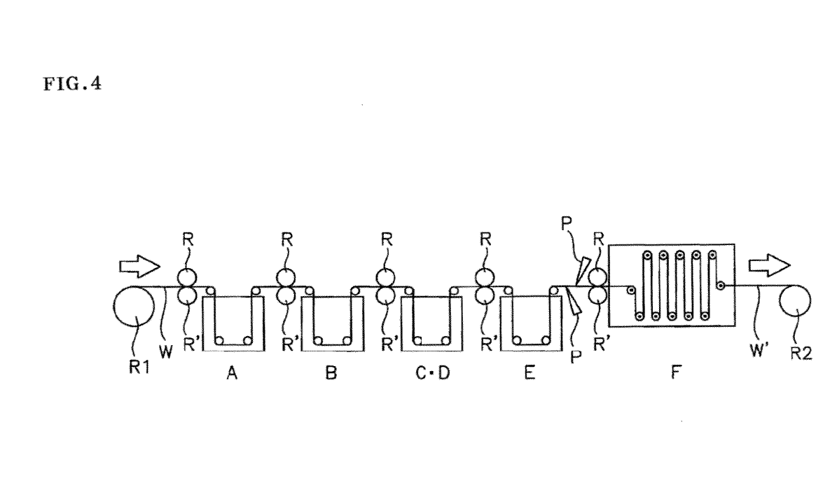

FIG. 4 is a schematic diagram showing a method for manufacturing a polarizer, which is in accordance with a conventional method for manufacturing a treated film. FIG. 4 shows a case where a swelling step A, a dyeing step B, a crosslinking and stretching step C/D, and a cleaning step E are each performed as a treatment step by immersing the resin film Win a liquid in a treatment tank. In FIG. 4, a drying step F is finally performed. When the method of the invention for manufacturing a treated film is used as a method for manufacturing a polarizer, at least one of the swelling step A, the dyeing step B, the crosslinking step C, the stretching step D, and the cleaning step E is performed using the one-side contact step, whereas other treatment steps may be performed, for example, using conventional immersion steps as shown in FIG. 4. In FIG. 4, liquid removal means P for removing liquid from both surfaces of the treated film W′ are provided downstream of the cleaning step E. In FIG. 4, guide rolls G are provided inside and outside each treatment tank. In FIG. 4, the crosslinking step C and the stretching step D are performed at the same time in the same treatment tank.

The swelling step A may include bringing a PVA film as a raw film into contact with a swelling liquid (treatment liquid). When this step is performed, the PVA film can be washed with water so that dirt and any anti-blocking agent can be washed away from the surface of the PVA film, and the PVA film is allowed to swell so that unevenness such as uneven dyeing can be prevented.

For example, water may be used as the swelling liquid. In addition, glycerin, potassium iodide, or the like may be added to the swelling liquid as needed. Glycerin is preferably added at a concentration of 5% by weight or less, and potassium iodide is preferably added at a concentration of 10% by weight or less. The swelling liquid preferably has a temperature in the range of 20 to 45° C., more preferably in the range of 25 to 40° C., even more preferably in the range of 30 to 35° C. In general, the time period for which the swelling liquid is brought into contact is preferably, but not limited to, 20 to 300 seconds, more preferably 30 to 200 seconds, in particular, preferably 30 to 120 seconds.

In the swelling step A, stretching may also be performed as needed. The stretch ratio is generally 6.5 times or less the original length of the PVA film. In view of optical properties, the stretch ratio is preferably from 1.2 to 6.5 times, more preferably from 1.5 to 5 times, even more preferably from 2 to 4.1 times. When stretching is performed in the swelling step A, stretching can be controlled to be at a low level in the stretching step D performed after the swelling step A, so that the stretching of the film can be so controlled as not to cause the breakage of the film. On the other hand, if the stretch ratio is high in the swelling step A, the stretch ratio can be too low in the stretching step, which is not preferable in view of optical properties particularly when the stretching step D is performed after the crosslinking step C.

The dyeing step B may include bringing the PVA film into contact with a solution (treatment liquid) containing iodine or a dichromatic dye so that the iodine or the dichromatic dye is adsorbed to the PVA film. The dyeing step B may be performed with a stretching step D.

A solution of iodine in a solvent may be used as the dyeing bath solution. While water is generally used as the solvent, an organic solvent compatible with water may be further added to the bath solution. The iodine concentration is preferably in the range of 0.01 to 10% by weight, more preferably in the range of 0.02 to 7% by weight, in particular, preferably in the range of 0.025 to 5% by weight. To further increase the dyeing efficiency, an iodide is preferably added. Examples of such an iodide include potassium iodide, lithium iodide, sodium iodide, zinc iodide, aluminum iodide, lead iodide, copper iodide, barium iodide, calcium iodide, tin iodide, and titanium iodide. The content of the iodide in the dyeing bath is preferably from 0.010 to 10% by weight, more preferably from 0.10 to 5% by weight. In particular, potassium iodide is preferably added, and the ratio (weight ratio) between iodine and potassium iodide is preferably in the range of 1:5 to 1:100, more preferably in the range of 1:6 to 1:80, in particular, preferably in the range of 1:7 to 1:70.

In general, the time period for which the dyeing liquid is brought into contact is preferably, but not limited to, in the range of 10 to 200 seconds, more preferably in the range of 15 to 150 seconds, even more preferably in the range of 20 to 130 seconds. The dyeing liquid preferably has a temperature in the range of 5 to 42° C., more preferably in the range of 10 to 35° C., even more preferably in the range of 12 to 30° C.

In the crosslinking step C, for example, the PVA film is brought into contact with a crosslinking liquid (treatment liquid) containing a crosslinking agent. The crosslinking step C may be performed at any time in the sequence. The crosslinking step C may be performed together with the stretching step D. The crosslinking step C may be performed twice or more. The crosslinking agent to be used may be a known conventional material, examples of which include a boron compound such as boric acid or borax, glyoxal, and glutaraldehyde. These may be used singly or in combination of two or more.

A solution of the crosslinking agent in a solvent may be used as the crosslinking liquid. While water is typically used as the solvent, an organic solvent compatible with water may be further added to the bath solution. The concentration of the crosslinking agent in the solution is preferably, but not limited to, in the range of 1 to 10% by weight, more preferably in the range of 2 to 6% by weight.

An iodide may be added to the crosslinking liquid so that uniform optical properties can be obtained in the plane of the polarizer. Examples of such an iodide include, but are not limited to, potassium iodide, lithium iodide, sodium iodide, zinc iodide, aluminum iodide, lead iodide, copper iodide, barium iodide, calcium iodide, tin iodide, and titanium iodide. The iodide content is preferably in the range of 0.05 to 15% by weight, more preferably in the range of 0.5 to 8% by weight. The iodides listed above may be used singly or in combination of two or more. When two or more of them are used in combination, a combination of boric acid and potassium iodide is preferred. The ratio (weight ratio) between boric acid and potassium iodide is preferably in the range of 1:0.1 to 1:3.5, more preferably in the range of 1:0.5 to 1:2.5.

In general, the temperature of the crosslinking liquid is preferably, but not limited to, in the range of 20 to 70° C., more preferably in the range of 20 to 40° C. In general, the time period for which the crosslinking liquid is brought into contact with the PVA film is preferably, but not limited to, in the range of 5 to 400 seconds, more preferably in the range of 50 to 300 seconds, even more preferably in the range of 150 to 250 seconds.

The stretching step D is generally performed using uniaxial stretching. This stretching method may be performed together with the dyeing step B and/or the crosslinking step C. The uniaxial stretching may be performed using a difference between the peripheral speeds of nip rolls placed upstream and downstream of the one-side treatment tank Y as mentioned above. For example, the stretching is generally performed after the dyeing step B. The stretching may also be performed together with the crosslinking step C.

The stretching step D should be performed in such a manner that the total stretch ratio falls within the range of 2 to 6.5 times the original length of the PVA film. The total stretch ratio is preferably from 2.5 to 6.3 times, more preferably from 3 to 6.1 times. Specifically, when stretching is performed in a step or steps other than the stretching step D, such as the swelling step A, as described below, the term “total stretch ratio” refers to the sum of all stretch ratios in these steps where stretching is performed. The total stretch ratio may be appropriately determined taking into account the stretch ratio in the swelling step A or other steps. If the total stretch ratio is low, orientation may be insufficient, and it may be not easy to obtain a polarizer with high optical properties (degree of polarization). On the other hand, if the total stretch ratio is too high, the stretching may easily cause breakage, or too thin a polarizer may be formed, which may have lower workability in the subsequent steps.

The treatment liquid used in the stretching step D may contain an iodide compound. When the treatment liquid contains an iodide compound, the concentration of the iodide compound is preferably from about 0.1 to about 10% by weight, more preferably from 0.2 to 5% by weight.

In general, the temperature of the treatment bath is preferably, but not limited to, 20 to 70° C., more preferably 20 to 40° C. In general, the time for which the PVA film is brought into contact with the treatment liquid is preferably, but not limited to, 5 to 100 seconds, more preferably 10 to 80 seconds, even more preferably 20 to 70 seconds.

In the polarizer manufacturing method, the cleaning step E is performed after the above steps. The cleaning step E may be performed using an iodide-containing aqueous solution (treatment liquid). The iodide to be used in the iodide-containing aqueous solution may be any of those listed above, and in particular, for example, potassium iodide, sodium iodide, or the like is preferred. Using the iodide-containing aqueous solution, a residue of boric acid, which has been used in the crosslinking step, can be washed away from the PVA film. When the aqueous solution is an aqueous potassium iodide solution, for example, its concentration is preferably in the range of 0.5 to 20% by weight, more preferably in the range of 1 to 15% by weight, even more preferably in the range of 1.5 to 7% by weight.

In general, the temperature of the iodide-containing aqueous solution is preferably, but not limited to, in the range of 15 to 40° C., more preferably in the range of 20 to 35° C. In general, the time period for which the treatment liquid is brought into contact with the PVA film is preferably, but not limited to, in the range of 2 to 30 seconds, more preferably in the range of 3 to 20 seconds.

In the polarizer manufacturing method including the swelling step A, the dyeing step B, the crosslinking step C, the stretching step D, and the cleaning step E, any of these steps may be performed without using the treatment step (one-side contact step) according to the invention. In such a case, the PVA film may be treated with the treatment liquid by any of various contact methods. Examples of such other contact methods include a method of immersing the film in the treatment liquid, a method of applying the treatment liquid to the film, and a method of spraying the treatment liquid on the film. When these methods are used, the immersion time and the temperature of the bath liquid may be appropriately selected as needed.

After all the above steps, the drying step is finally performed, so that a polarizer is obtained. The drying step may be performed using an appropriate method such as natural drying, air drying, or drying by heating, in general, preferably using drying by heating. When drying by heating is performed, in general, the heating temperature is preferably, but not limited to, in the range of 25 to 80° C., more preferably in the range of 30 to 70° C., even more preferably in the range of 30 to 60° C. The drying time is preferably from about 1 to about 10 minutes.

According to a conventional method, a transparent protective film may be provided on at least one side of the resulting polarizer, so that a polarizing plate can be obtained. A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film.

Thickness of the transparent protective film can be properly determined and generally in the range of from about 1 to about 500 μm from the viewpoint of a strength, workability such as handlability, requirement for a thin film and the like. Especially, the thickness is preferably in the range of from 1 to 300 μm and more preferably in the range of from 5 to 200 μm. Therefore, it is particularly preferred that the transparent protective film has a thickness of 5 to 150 μm.

Note that in a case where the transparent protective films are provided on both sides of the polarizer, the protective films made from the same polymer may be used on both sides thereof or alternatively, the protective films made from polymer materials different from each other may also be used on respective both sides thereof.

The transparent protective film to be used may be a retardation plate having an in-plane retardation of 40 nm or more and/or a thickness direction retardation of 80 nm or more. The in-plane retardation is generally controlled in the range of 40 to 200 nm, and the thickness direction retardation is generally controlled in the range of 80 to 300 nm. The retardation plate for use as the transparent protective film also has the function of the transparent protective film and thus can contribute to a reduction in thickness.

Examples of the retardation plate include a birefringent film produced by uniaxially or biaxially stretching a polymer material, an oriented liquid crystal polymer film, and an oriented liquid crystal polymer layer supported on a film. Although the thickness of the retardation plate is also not restricted, it is generally from about 20 to about 150 μm.

The film with retardation may be bonded to a separate transparent protective film with no retardation, so that the retardation function can be bonded to the transparent protective film.

The transparent protective film may be subjected to surface modification treatment before it is applied with the adhesive. Specific examples of such treatment include corona treatment, plasma treatment, primer treatment, saponification treatment, etc.

A hard coat layer may be prepared, or antireflection processing layer, processing aiming at sticking prevention, diffusion or anti glare may be performed onto the face on which the polarizer of the above described transparent protective film has not been adhered.

The polarizer and the transparent protective film are bonded together using an adhesive. For example, the adhesive may be an isocyanate-based adhesive, a polyvinyl alcohol-based adhesive, a gelatin-based adhesive, a vinyl latex-based adhesive, an aquatic polyester-based adhesive, or the like. The adhesive is generally used in the form of an aqueous solution, which generally has a solids content of 0.5 to 60% by weight. Besides the above, the adhesive between the polarizer and the transparent protective film may also be an ultraviolet-curable adhesive, an electron beam-curable adhesive, or the like. Electron beam-curable adhesives for polarizing plates have good tackiness to the above various transparent protective films. The adhesive for use in the present invention may also contain a metal compound filler.

In the invention, a polarizing plate may be manufactured by bonding the transparent protective film and the polarizer together with the adhesive. The adhesive may be applied to one or both of the transparent protective film and the polarizer. After the bonding, a drying step may be performed, so that an adhesive layer can be formed, which is made of a dried coating layer. The polarizer and the transparent protective film can be bonded together using a roll laminator or the like. The thickness of the adhesive layer is generally, but not limited to, about 30 to about 1,000 nm.

A polarizing plate of the invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Particularly preferred is a reflective or transflective polarizing plate further including a reflector or a transflector placed on the polarizing plate according to the invention, an elliptically or circularly polarizing plate further including a retardation plate placed on the polarizing plate, a wide viewing angle polarizing plate further including a viewing angle compensation film placed on the polarizing plate, or a polarizing plate further including a brightness enhancement film placed on the polarizing plate.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, a pressure-sensitive adhesive layer may also be prepared for adhesion with other members, such as a liquid crystal cell etc. As pressure-sensitive adhesive that forms pressure-sensitive layer is not especially limited, and, for example, acrylic type polymers; silicone type polymers; polyesters, polyurethanes, polyamides, polyethers; fluorine type and rubber type polymers may be suitably selected as a base polymer. Especially, a pressure-sensitive adhesive such as acrylics type pressure-sensitive adhesives may be preferably used, which is excellent in optical transparency, showing adhesion characteristics with moderate wettability, cohesiveness and adhesive property and has outstanding weather resistance, heat resistance, etc.

The pressure-sensitive adhesive layer may be formed on one or both sides of the polarizing plate or the optical film by any appropriate method. For example, such a method may be a method including dissolving or dispersing a base polymer or a composition thereof in an appropriate single solvent such as toluene or ethyl acetate or a mixture thereof to prepare an about 10 to 40% by weight pressure-sensitive adhesive solution and directly applying the solution to the polarizing plate or the optical film by any appropriate spreading method such as casting or coating; or a method including forming a pressure-sensitive adhesive layer on a separator similarly to the above method and transferring it onto the polarizing plate or the optical film.

The pressure-sensitive adhesive layer may also be formed as a laminate of layers different in composition, type or other properties on one or both sides of the polarizing plate or the optical film. When pressure-sensitive adhesive layers are provided on both sides, they may be different in composition, type, thickness, or other properties between the front and back sides of the polarizing plate or the optical film. The thickness of the pressure-sensitive adhesive layer is generally from 1 to 500 μm, preferably from 5 to 200 μm, more preferably from 10 to 100 μm, and it may be appropriately determined depending on the purpose of use, adhering strength, or other factors.

A temporary separator is attached to an exposed side of a pressure-sensitive adhesive layer to prevent contamination etc., until it is practically used. Thereby, it can be prevented that foreign matter contacts pressure-sensitive adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In the invention, the ability to absorb ultraviolet light may be imparted to the polarizer, the transparent protective film used to form the polarizing plate, the optical film, or to each layer such as the pressure-sensitive adhesive layer, for example, by a treatment with an ultraviolet absorber such as a salicylic ester-based compound, a benzophenol-based compound, a benzotriazole-based compound, a cyanoacrylate-based compound, or a nickel complex salt-based compound.

The polarizing plate or the optical film of the invention is preferably used to form various types of image displays such as liquid crystal displays. Liquid crystal displays may be formed according to conventional techniques. Specifically, liquid crystal displays are generally formed by appropriately assembling a liquid crystal cell and the polarizing plate or the optical film and optionally other component such as a lighting system and incorporating a driving circuit according to any conventional technique, except that the polarizing plate or the optical film of the invention is used. Any type of liquid crystal cell may also be used such as a TN type, an STN type, a n type a VA type and IPS type.

Suitable liquid crystal displays, such as liquid crystal display with which the polarizing plate or the optical film has been located at one side or both sides of the liquid crystal cell, and with which a backlight or a reflective plate is used for a lighting system may be manufactured. In this case, the polarizing plate or the optical film may be installed in one side or both sides of the liquid crystal cell. When installing the optical films in both sides, they may be of the same type or of different type. Furthermore, in assembling a liquid crystal display, suitable parts, such as diffusion layer, anti-glare layer, antireflection film, protective plate, prism array, lens array sheet, optical diffusion sheet, and backlight, may be installed in suitable position in one layer or two or more layers.

### EXAMPLES

Hereinafter, preferred examples of the invention will be illustratively described in detail. It will be understood that the materials, the contents, and other conditions described in the examples are not intended to limit the invention unless otherwise stated.

### Example 1

### Preparation of PVA Film

A raw PVA film (VF-PS750 (trade name) manufactured by KURARAY CO., LTD.) was provided. The PVA film was 3,100 mm wide and 75 thick.

### Preparation of Polarizer

A swelling step, a dyeing step, a crosslinking and stretching step, a cleaning step, and a drying step were sequentially performed using the manufacturing apparatus of the invention shown in FIG. 3. More specifically, the steps were performed as described below. Each one-side treatment tank used in each of the swelling step, the dyeing step, the crosslinking and stretching step, and the cleaning step was horizontally placed. The PVA film was fed at a rate of 12 m/minute, and the treatment liquid in each one-side treatment tank was 300 mm deep. The lower surface of the resin film was brought into contact with the surface of the treatment liquid in each one-side treatment tank. In the apparatus shown in FIG. 3, liquid removal means (a scraper made of SUS) for removing liquid from the lower surface of the PVA film was provided downstream of each of all one-side treatment tanks Y.

### <<Swelling Step>>

The one-side treatment tank was filled with a swelling liquid (water at a temperature of 30° C.). The PVA film was brought into contact with the swelling liquid for a time period of 30 seconds, and the PVA film was allowed to swell while it was stretched in the longitudinal direction. The stretch ratio in the longitudinal direction was 2.4 times the length of the unstretched PVA film.

### <<Dyeing Step>>

The one-side treatment tank was filled with a dyeing liquid (a 0.035% by weight iodine aqueous solution (containing 0.07% by weight of potassium iodide) at a temperature of 25° C.). The PVA film was brought into contact with the dyeing liquid for a time period of 30 seconds, and the PVA film was dyed while it was stretched in the longitudinal direction. The stretch ratio in the longitudinal direction was 3.3 times the length of the unstretched PVA film.

### <<Crosslinking and Stretching Step>>

The one-side treatment tank was filled with a crosslinking liquid (an aqueous solution containing 2.5% by weight of boric acid and 2% by weight of potassium iodide at a temperature of 35° C.). The PVA film was brought into contact with the crosslinking liquid for a time period of 60 seconds, and the PVA film was dyed while it was stretched in the longitudinal direction. The stretch ratio in the longitudinal direction was 6 times the length of the unstretched PVA film.

### <<Cleaning Step>>

The one-side treatment tank was filled with a conditioner (a 2.5% by weight hydrogen iodide aqueous solution at a temperature of 30° C.). The PVA film was brought into contact with the conditioner for a time period of 15 seconds.

### <<Drying Step>>

After the cleaning step, the PVA film was dried at a temperature of 40° C. for a time period of 200 seconds. Subsequently, the PVA film was cut at both ends and then wound together with a polyethylene terephthalate interleaving sheet. As a result, a roll of polarizer film was obtained. The resulting polarizer had a thickness of 30 μm.

### Preparation of Polarizing Plate

A polarizing plate was prepared as follows. Using a laminator, triacetylcellulose films (TD80UL (trade name) manufactured by FUJIFILM Corporation) were bonded to both sides of the polarizer with a PVA adhesive (NH18 (trade name) manufactured by The Nippon Synthetic Chemical Industry Co., Ltd.). The bonding temperature was 25° C. Subsequently, the resulting laminate was dried under the conditions of 55° C. and 300 seconds using an air circulation-type thermostatic oven. A polarizing plate was thus obtained.

### Comparative Example 1

### Preparation of Polarizer

The same raw PVA film was used as in Example 1. A swelling step, a dyeing step, a crosslinking and stretching step, a cleaning step, and a drying step were sequentially performed using the manufacturing apparatus shown in FIG. 4. More specifically, the steps were performed as described below. The PVA film was fed at a rate of 12 m/minute. In the apparatus shown in FIG. 4, liquid removal means (a scraper made of SUS) for removing liquid from both surfaces of the PVA film was provided downstream of each of all treatment tanks.

### <<Swelling Step>>

The treatment tank was filled with a swelling liquid (water at a temperature of 30° C.). The PVA film was brought into contact with the swelling liquid for a time period of 30 seconds, and the PVA film was allowed to swell while it was stretched in the longitudinal direction. The stretch ratio in the longitudinal direction was 2.4 times the length of the unstretched PVA film.

### <<Dyeing Step>>

The treatment tank was filled with a dyeing liquid (a 0.035% by weight iodine aqueous solution (containing 0.07% by weight of potassium iodide) at a temperature of 25° C.). The PVA film was brought into contact with the dyeing liquid for a time period of 30 seconds, and the PVA film was dyed while it was stretched in the longitudinal direction. The stretch ratio in the longitudinal direction was 3.3 times the length of the unstretched PVA film.

### <<Crosslinking and Stretching Step>>

The treatment tank was filled with a crosslinking liquid (an aqueous solution containing 2.5% by weight of boric acid and 2% by weight of potassium iodide at a temperature of 35° C.). The PVA film was brought into contact with the crosslinking liquid for a time period of 60 seconds, and the PVA film was dyed while it was stretched in the longitudinal direction. The stretch ratio in the longitudinal direction was 6 times the length of the unstretched PVA film.

### <<Cleaning Step>>

The treatment tank was filled with a conditioner (a 2.5% by weight hydrogen iodide aqueous solution at a temperature of 30° C.) The PVA film was brought into contact with the conditioner for a time period of 15 seconds.

### <<Drying Step>>

The drying step was performed in the same manner as in Example 1.

### Preparation of Polarizing Plate

In Comparative Example 1, a polarizing plate was prepared in the same manner as in Example 1.

### Comparative Example 2

### Preparation of PVA Film

The same raw PVA film was used as in Example 1.

### Preparation of Polarizer

A swelling step, a dyeing step, a crosslinking step, a stretching step, a cleaning step, and a drying step were sequentially performed as described below. The PVA film was fed at a rate of 12 m/minute. Liquid removal means (a scraper made of SUS) for removing liquid from the lower surface of the PVA film was provided downstream of each of all treatment tanks.

### <<Swelling Step>>

The same raw PVA film as in Example 1 was allowed to swell by spraying water (swelling liquid at a temperature of 30° C.) for 30 seconds on the lower surface of the film while the film was longitudinally stretched. The distance between the spray nozzle and the PVA film was 30 cm, and the swelling liquid was sprayed in an amount of 1.0 mL/1 cm² on the PVA film. The spray device used was T-AFPV (trade name) manufactured by DeVILBISS. The longitudinal stretch ratio was 2.4 times the length of the unstretched PVA film. The spray time was calculated from the spray area and the feed rate. The spray time represents the time for which any point on the film is subjected to spraying.

### <<Dyeing Step>>

After the swelling, the PVA film was dyed by spraying a dyeing liquid (a 0.035% by weight iodine aqueous solution (containing 0.07% by weight of potassium iodide) at a temperature of 25° C.) for 30 seconds on the lower surface of the PVA film while the film was longitudinally stretched. The distance between the spray nozzle and the PVA film was 30 cm, and the dyeing liquid was sprayed in an amount of 1.0 mL/1 cm² on the PVA film. The spray device used was the same type as used in the swelling step. The longitudinal stretch ratio was 3.3 times the length of the unstretched PVA film.

### <<Crosslinking Step>>

After the dyeing, a crosslinking liquid (an aqueous solution containing 2.5% by weight of boric acid and 2% by weight of KI at a temperature of 35° C.) was sprayed for 60 seconds on the lower surface of the PVA film. The distance between the spray nozzle and the PVA film was 30 cm, and the crosslinking liquid was sprayed in an amount of 1 mL/1 cm² on the PVA film. The spray device used was the same type as used in the swelling step. The longitudinal stretch ratio was 6 times the length of the unstretched PVA film.

### <<Cleaning Step>>

After the crosslinking, a stretching liquid (an aqueous solution containing 2.5% by weight of boric acid and 2% by weight of KI at a temperature of 35° C.) was sprayed for 15 seconds on the lower surface of the PVA film. The distance between the spray nozzle and the PVA film was 30 cm, and the crosslinking liquid was sprayed in an amount of 0.6 mL/1 cm² on the PVA film. The spray device used was the same type as used in the swelling step.

### <<Drying Step>>

The drying step was performed in the same manner as in Example 1.

### Preparation of Polarizing Plate

In Comparative Example 2, a polarizing plate was prepared in the same manner as in Example 1.

### Comparative Example 3

### Preparation of PVA Film

The same raw PVA film was used as in Example 1.

### Preparation of Polarizer

A swelling step, a dyeing step, a crosslinking step, a stretching step, a cleaning step, and a drying step were sequentially performed as described below. The PVA film was fed at a rate of 12 m/minute. Liquid removal means (a scraper made of SUS) for removing liquid from the lower surface of the PVA film was provided downstream of each of all treatment tanks.

### <<Swelling Step>>

The PVA film was allowed to swell by applying water (swelling liquid at a temperature of 30° C.) to the upper surface of the film while the film was longitudinally stretched. The time from the application to the liquid removal was 15 seconds, and the amount of application was 15 ml/second. The applicator used was a die coater. The longitudinal stretch ratio was 2.4 times the length of the unstretched PVA film.

### <<Dyeing Step>>

After the swelling, the PVA film was dyed by applying a dyeing liquid (a 0.035% by weight iodine aqueous solution (containing 0.07% by weight of potassium iodide) at a temperature of 25° C.) to the upper surface of the PVA film, while the film was longitudinally stretched. The time from the application to the liquid removal was 15 seconds, and the amount of application was 12 ml/second. The applicator used was the same type as used in the swelling step. The longitudinal stretch ratio was 3.3 times the length of the unstretched PVA film.

### <<Crosslinking Step>>

After the dyeing, a crosslinking liquid (an aqueous solution containing 2.5% by weight of boric acid and 2% by weight of KI at a temperature of 35° C.) was applied to the upper surface of the PVA film. The time from the application to the liquid removal was 30 seconds, and the amount of application was 10 ml/second. The applicator used was the same type as used in the swelling step. The longitudinal stretch ratio was 6 times the length of the unstretched PVA film.

### <<Cleaning Step>>

After the crosslinking, a stretching liquid (an aqueous solution containing 2.5% by weight of boric acid and 2% by weight of KI at a temperature of 35° C.) was applied to the upper surface of the PVA film. The application time (the time for which the film is brought into contact with the conditioner) was 10 seconds, and the amount of application was 10 ml/second. The applicator used was the same type as used in the swelling step.

### <<Drying Step>>

The drying step was performed in the same manner as in Example 1.

### Preparation of Polarizing Plate

In Comparative Example 2, a polarizing plate was prepared in the same manner as in Example 1.

### Example 2

A polarizer and a polarizing plate were prepared in the same manner as in Example 1, except that VF-PS400 (trade name) manufactured by KURARAY CO., LTD. was used instead as the raw PVA film. The PVA film was 3,100 mm wide and 40 μm thick. The resulting polarizer had a thickness of 16 μm.

### Comparative Examples 4 to 6

Polarizers and polarizing plates were prepared in the same manner as in Comparative Examples 1 to 3, respectively, except that VF-PS400 (trade name) manufactured by KURARAY CO., LTD. was used instead as the raw PVA film. The PVA film was 3,100 mm wide and 40 μm thick. Each resulting polarizer had a thickness of 16 μm.

The polarizers and the polarizing plates obtained in the examples and the comparative examples were evaluated as described below. Table 1 shows the results.

### (Level of Unevenness in Polarizer)

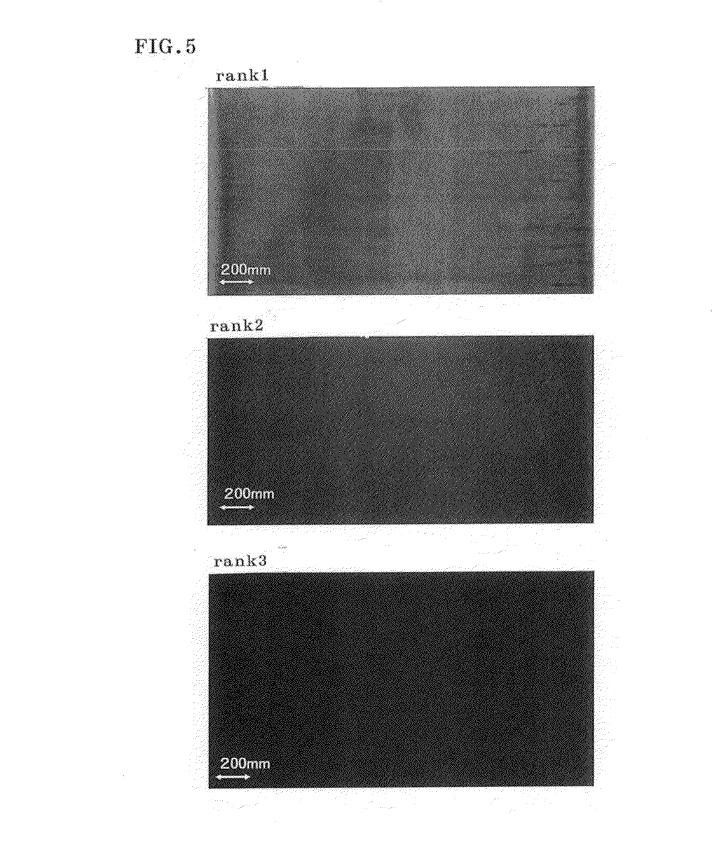

The polarizing plate prepared in each of the examples and the comparative examples was evaluated for unevenness at three points on an arbitrary straight line along the widthwise direction. Among the results of the evaluation, the worst result was used as the representative result on the straight line. The evaluation was further performed on different straight lines. The results are shown in Table 1 below. Table 1 shows the results of the evaluation of unevenness on the respective straight lines (n=1-3). In the evaluation, the level of unevenness was visually observed from a position 50 cm vertically above the polarizer, and classified into three grades, from rank 1 to rank 3 (see FIG. 5).

Rank 1: Unevenness is clearly observed even in a bright place.

Rank 2: Unevenness is observed in a dark place.

Rank 3: Unevenness is not observed in a dark place.

### (Detection of Scratches on Polarizer Film)

The polarizing plate (100 m along the longitudinal direction) prepared in each of the examples and the comparative examples was visually checked for whether or not there were scratches (bright spots) of 200 μm or more on the polarizing plate over a length of 100 m.

TABLE 1

| | | | | | Evaluations | | | | |
|---|---|---|---|---|---|---|---|---|---|
| | | Contact time | Surface | Polarizer | | | | Scratches | |
| | Treatment | (seconds) in | subjected to | thickness | Unevenness level | | | (pcs/100 m) | Easiness |
| | method | dyeing step | liquid removal | (μm) | n = 1 | n = 2 | n = 3 | detected on film | of setting up |
| Example 1 | Contact | 30 | One side | 30 | 3 | 3 | 3 | 13 | ∘ |
| | method | | | | | | | | |
| Comparative | Immersion | 30 | Both sides | 30 | 3 | 3 | 3 | 42 | ∘ |
| Example 1 | method | | | | | | | | |
| Comparative | Spray | 30 | One side | 30 | 1 | 1 | 1 | 12 | ∘ |
| Example 2 | method | | | | | | | | |
| Comparative | Coating | 15 | One side | 30 | 2 | 3 | 2 | 15 | x |
| Example 3 | method | | | | | | | | |
| Example 2 | Contact | 30 | One side | 16 | 3 | 3 | 3 | 23 | ∘ |
| | method | | | | | | | | |
| Comparative | Immersion | 30 | Both sides | 16 | 3 | 3 | 3 | 133 | ∘ |
| Example 4 | method | | | | | | | | |
| Comparative | Spray | 30 | One side | 16 | 1 | 1 | 1 | 21 | ∘ |
| Example 5 | method | | | | | | | | |
| Comparative | Coating | 15 | One side | 16 | 2 | 2 | 2 | 25 | x |
| Example 6 | method | | | | | | | | |

Table 1 shows that in the polarizer of Example 1 or 2, unevenness is successfully reduced, and the film has fewer scratches. On the other hand, it is apparent that when a polarizer is manufactured using an immersion method in forming a polarizing plate as in Comparative Example 1 or 4, more scratches are formed on the film, because liquid is removed from both sides of the film. It is also apparent that when a polarizer is manufactured using a spray method in forming a polarizing plate as in Comparative Example 2 or 5, unevenness occurs more frequently.

When a coating method is used to form a polarizing plate as in Comparative Example 3 or 6, the occurrence of unevenness can be slightly reduced, but it is not easy to set up the manufacturing apparatus because a high degree of set-up accuracy (0.5 mm or less) is required of the gap between the coating unit and the film in the transverse direction. In Table 1, the item “easiness of setting up” is evaluated as “X” (not easy) for Comparative Examples 3 and 6. For other examples and comparative examples, the item “easiness of setting up” is evaluated as “◯” (easy) because such a high degree of set-up accuracy is not required.

### DESCRIPTION OF REFERENCE SIGNS

R, R′ Nip roll
X Treatment liquid
Y One-side treatment tank
W Resin film
P Liquid removal means
Q Treatment liquid supply unit

1.-10. (canceled)

11. A method for manufacturing a treated resin film from a long resin film, the method comprising at least treatment steps each including treating the long resin film by bringing the long resin film into contact with a treatment liquid in a treatment tank, while feeding the long resin film, wherein
at least one of the treatment steps is a one-side contact step including bringing a lower surface of the resin film into contact with a surface of the treatment liquid in the treatment tank that is filled with the treatment liquid, and
nip rolls are placed downstream of at least one one-side treatment tank for the one-side contact step, and the one-side treatment tank is inclined that a downstream side of the one-side treatment tank is higher than an upstream side of the one-side treatment tank with respect to the direction in which the long resin film is fed.

12. The method for manufacturing a treated resin film according to claim 11, further comprising the step of removing liquid only from a lower surface of the treated film subsequent to the one-side contact step.

13. The method for manufacturing a treated resin film according to claim 11, wherein the one-side contact step is performed while the treatment liquid is supplied, to the one-side treatment tank, in an amount equal to or larger than the amount of the treatment liquid taken out of the one-side treatment tank.

14. The method for manufacturing a treated resin film according to claim 11, wherein nip rolls are placed upstream of the one-side treatment tank, corresponding to the nip rolls placed downstream of the one-side treatment tank, and the one-side contact step is performed while the long resin film is stretched in longitudinal direction of the long resin film by making the peripheral speed of the nip rolls upstream of the one-side treatment tank different from the peripheral speed of the nip rolls downstream of the one-side treatment tank.

15. The method for manufacturing a treated resin film according to claim 11, wherein the treated film obtained by subjecting the resin film to the treatment steps is an optical film.

16. The method for manufacturing a treated resin film according to claim 15, wherein the resin film is a polyvinyl alcohol-based film,
the treatment steps include at least a swelling step, a dyeing step, a crosslinking step, a stretching step, and a cleaning step,
at least one of the swelling step, the dyeing step, the crosslinking step, the stretching step, and the cleaning step is performed using the one-side contact step, and
a polarizer is manufactured as the treated film.

17. An apparatus for manufacturing a treated film, comprising:
at least one treatment tank filled with a treatment liquid with which a desired treatment is to be performed on a resin film;
the at least one treatment tank being a one-side treatment tank placed under the resin film being fed, the one-side treatment tank being so placed that a surface of the treatment liquid comes into contact with a lower surface of the resin film; and
nip rolls placed downstream of the at least one one-side treatment tank, and the one-side treatment tank is inclined that a downstream side of the one-side treatment tank is higher than an upstream side of the one-side treatment tank with respect to the direction in which the long resin film is fed.

18. The apparatus according to claim 17, comprising means for removing liquid from a lower surface of the film treated with the treatment liquid, wherein the means for removing liquid is provided downstream of the one-side treatment tank.

19. The apparatus according to claim 17, a treatment liquid supply unit for continuously supplying the treatment liquid to the one-side treatment tank is provided with the one-side treatment tank.

20. The apparatus according to claim 17, comprising nip rolls placed upstream of the one-side treatment tank, corresponding to the nip rolls placed downstream of the one-side treatment tank.
